(19) United States
(12) Patent Application Publication
(10) Pub. No.: US 2026/0154039 A1
(43) Pub. Date: Jun. 4, 2026

(54) METHOD AND SYSTEM FOR DOCUMENT PROFILE GENERATION AND USE

(71) Applicant: Verizon Patent and Licensing Inc., Basking Ridge, NJ (US)

(72) Inventors: Mourad B. Takla, Hillsborough, NJ (US); Mason Ng, Jersey City, NJ (US)

(21) Appl. No.: 18/966,395

(22) Filed: Dec. 3, 2024

(51) Int. Cl. G06F 8/10; G06F 8/35; G06F 16/334; G06F 40/279; H04L 51/02

(52) U.S. Cl. CPC G06F 8/10; G06F 8/35; G06F 16/3344; G06F 40/279; H04L 51/02

(57) ABSTRACT

One or more computing devices, systems, and/or methods for automatically determining document profiles for documents and/or using the document profiles to generate content in response to queries are provided. In an example, a first document may be identified. A first language model may be used to determine a set of features based upon the first document. A second language model may be used to determine a plurality of sets of attributes based upon the set of features and the first document. The plurality of sets of attributes may include a first set of attributes associated with a first feature of the set of features and/or a second set of attributes associated with a second feature of the set of features. A first document profile associated with the first document may be generated based upon the set of features and the plurality of sets of attributes.

### BACKGROUND

A chatbot may be used to conduct conversations (e.g., chat conversations) with users. For example, the chatbot may use a generative artificial intelligence (AI) tool to generate responses to user queries.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating an example system for automatically determining document profiles for documents and/or using the document profiles to generate content in response to queries, according to some embodiments.

FIG. 1B is a diagram illustrating an example representation of a document profile associated with a document, according to some embodiments.

FIG. 1C is a diagram illustrating an example system for automatically determining document profiles for documents and/or using the document profiles to generate content in response to queries, where a messaging interface is displayed via a first client device, according to some embodiments.

FIG. 1D is a diagram illustrating an example system for automatically determining document profiles for documents and/or using the document profiles to generate content in response to queries, where a third message is transmitted by a communication system to a first client device, according to some embodiments.

FIG. 1E is a diagram illustrating an example system for automatically determining document profiles for documents and/or using the document profiles to generate content in response to queries, where a third message is displayed via a messaging interface, according to some embodiments.

FIG. 1F is a diagram illustrating an example system for automatically determining document profiles for documents and/or using the document profiles to generate content in response to queries, where a network action is performed, according to some embodiments.

FIG. 2 is a flow chart illustrating an example method for automatically determining document profiles for documents and/or using the document profiles to generate content in response to queries, according to some embodiments.

FIG. 3 is a diagram illustrating a scenario implemented by an example system for automatically determining document profiles for documents and/or using the document profiles to generate content in response to queries, according to some embodiments.

FIG. 4 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

One or more systems and/or techniques for automatically determining document profiles for documents and/or using the document profiles to generate content in response to queries are provided. A document profile may be generated by an automated document profile determination module based upon a document (e.g., at least one of a captured data packet file, a methods of procedure (MOP) document for configuring and/or reconfiguring a network element, a Customer Information Questionnaire (CQ) document, etc.). The document profile may be indicative of (i) a set of features associated with the document, (ii) a plurality of sets of attributes associated with the set of features (e.g., a set of attributes may comprise feature categories of a feature of the set of features), and/or (iii) a plurality of sets of keywords associated with the plurality of sets of attributes (e.g., a set of keywords may define an attribute). The document profile may be used by a content generation system to generate a response to a query (using a language model, for example).

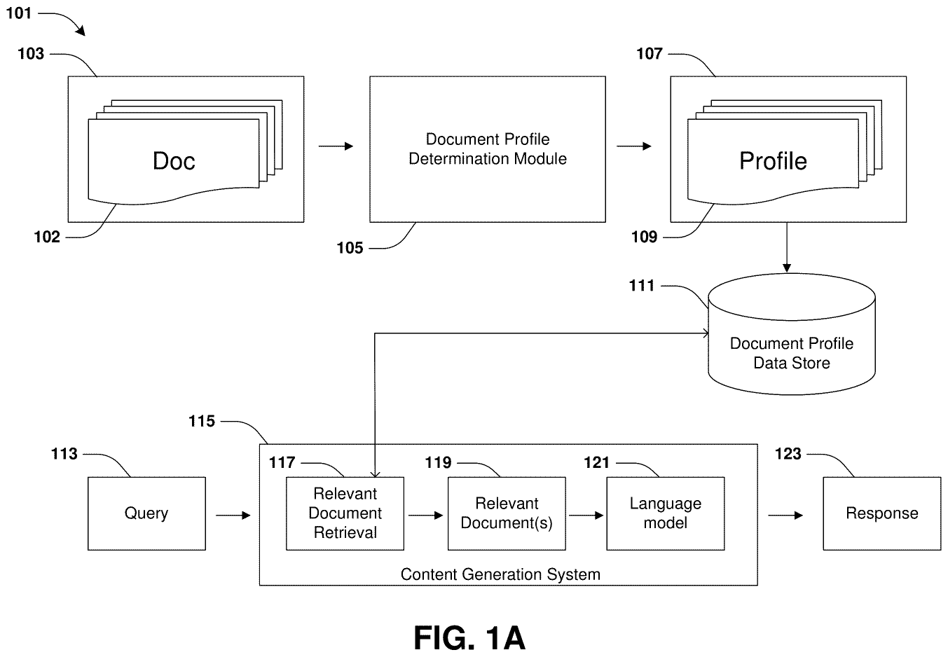

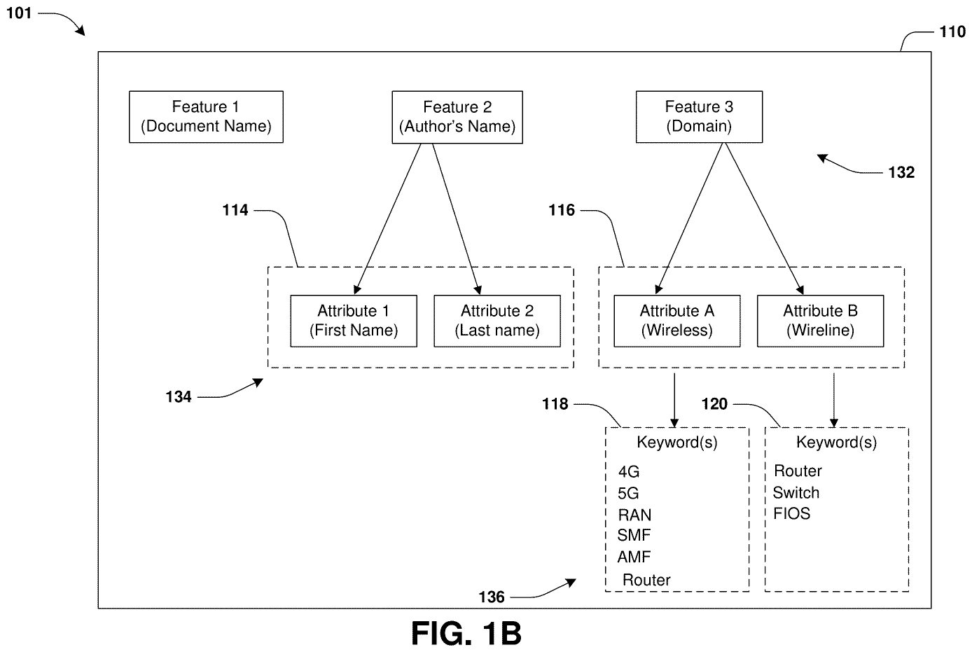

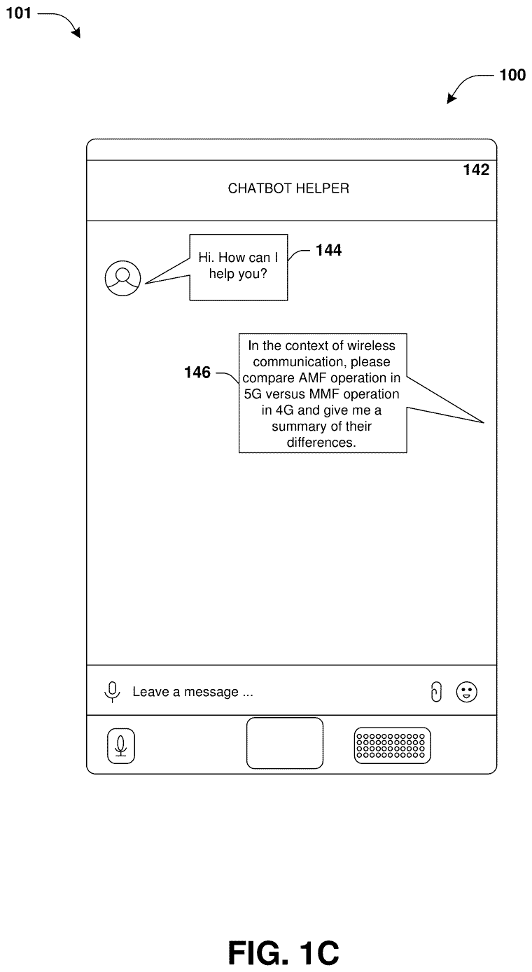

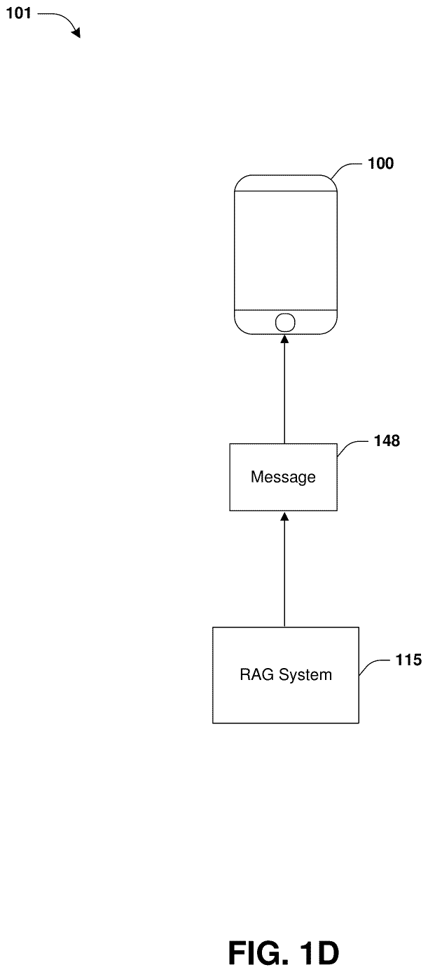

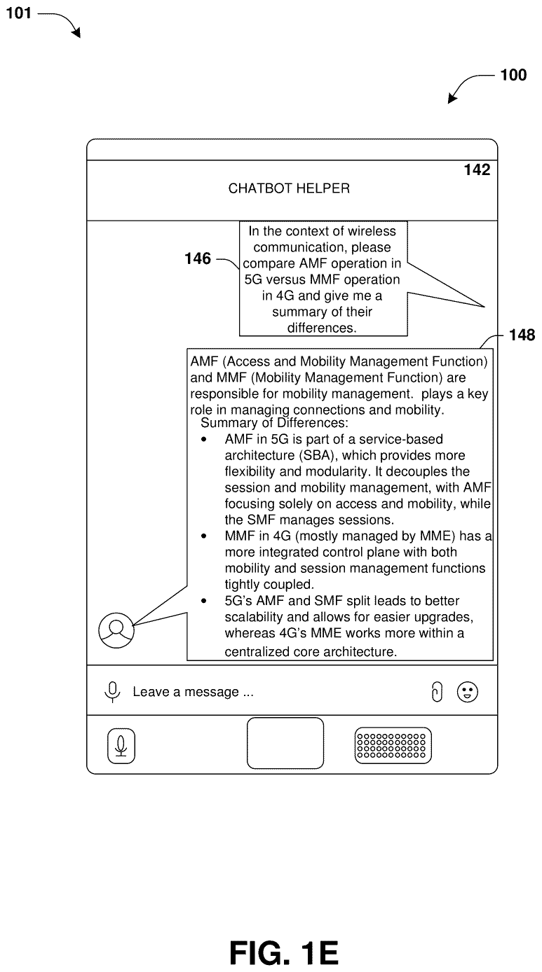

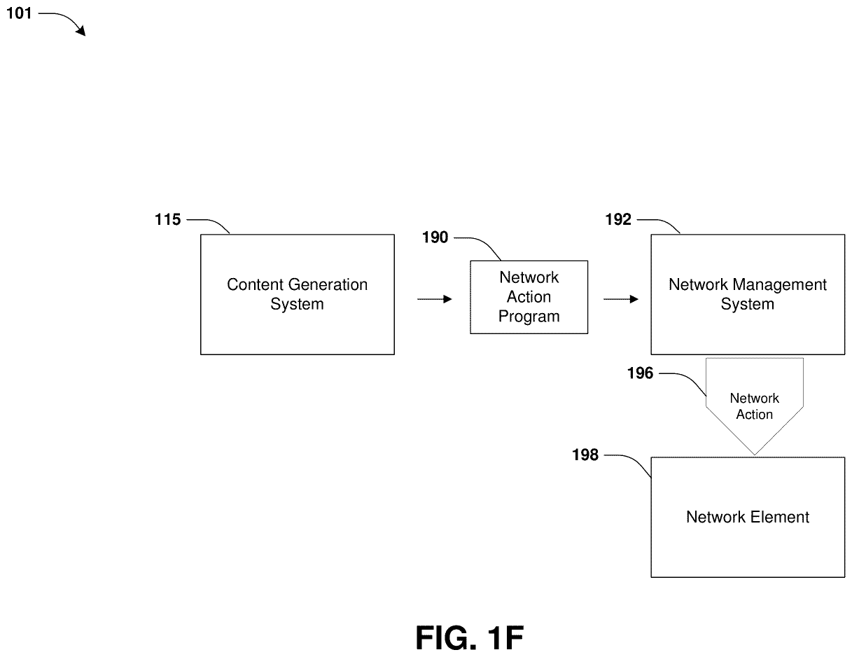

FIGS. 1A-1F illustrate examples of a system 101 for automatically determining document profiles for documents and/or using the document profiles to generate content in response to queries. FIG. 1A illustrates a document profile determination module 105 (e.g., an automated document profile determination module) generating profile data 107 comprising a set of document profiles (e.g., a set of one or more document profiles) based upon a set of documents 103 (e.g., a set of one or more documents) to store in a document profile data store 111. In some examples, document profiles (e.g., contextual profiles) stored in the document profile data store 111 are used by a content generation system 115 to generate a response 123 to a query 113. In some examples, the query 113 may be submitted by a first user via an interface associated with the content generation system 115. The profile data 107 and/or the set of document profiles may correspond to automatically generated metadata that the content generation system 115 may use to produce responses more accurately and/or efficiently. In some examples, the content generation system 115 comprises a retrieval augmented generation (RAG) system and/or other type of generative system.

The content generation system 115 may be part of a chatbot (also known as chatterbot) system comprising a communication system (e.g., a conversational system). For example, the response 123 may be displayed via a messaging interface 142 (shown in FIG. 1C). For example, the chatbot system (e.g., the content generation system 115 and/or the communication system) may be used to conduct a conversation (e.g., a chat conversation) with the first user via the messaging interface 142. The chatbot system may be used to provide one or more services to the first user, such as one or more services requested in one or more messages submitted by the first user.

The set of documents 103 may comprise at least one of a first document 102, a second document, etc. The set of documents 103 comprises one or more types of documents. A document (e.g., at least one of the first document 102, the second document, etc.) of the set of documents 103 comprises at least one of a set of text, an image, a video, an article (e.g., a news article, an informational article, an encyclopedic article, a journal article, etc. with text and/or images), a glossary entry (e.g., the set of documents 103 may comprise some and/or all entries of a glossary), a dictionary entry (e.g., the set of documents 103 may comprise some and/or all entries of a dictionary), etc.

In some examples, the set of documents 103 may comprise a set of field-related documents (e.g., a set of one or more field-related documents) associated with a field. The field may be associated with the chatbot system and/or one or more services provided by the chatbot system. The field may correspond to an entity and/or a category associated with the chatbot system, such as an entity (e.g., at least one of a company, a business, etc.) associated with the chatbot system and/or a category associated with services (e.g., at least one of telecommunication service, transportation service, etc.) that are provided and/or facilitated by the chatbot system and/or the entity (e.g., the chatbot system may be used for providing informational content associated with the category and/or may be used for providing customer service for services associated with the category).

A document (e.g., at least one of the first document 102, the second document, etc.) of the set of field-related documents may comprise text (e.g., structured sets of text) comprising at least one of definitions of terms associated with the field, usage of terms associated with the field, etc. For example, the document may comprise at least one of text from one or more articles (e.g., news articles, encyclopedia articles, etc.) related to the category and/or the entity, text from one or more social media posts and/or blogs related to the category and/or the entity, text from documentation (e.g., datasheets, product and/or service specifications, etc.) related to the category and/or the entity, text from one or more webpages related to the category and/or the entity, a glossary and/or dictionary of terms related to the category and/or the entity, etc. In an example, a processor may be used to read memory on which content associated with the field (e.g., at least one of articles, social media posts, blogs, documentation, webpages, a glossary, a dictionary, etc.) is stored and/or the processor may be used to extract text from the content and/or store the text as a document of the set of field-related documents in a data store on which the set of field-related documents are stored.

In an example in which the entity is a telecommunication service provider and/or the category is telecommunication services, a document (e.g., at least one of the first document 102, the second document, etc.) of the set of field-related documents may comprise text comprising at least one of definitions of terms associated with the telecommunication service provider and/or telecommunication services, usage of terms associated with the telecommunication service and/or telecommunication services (e.g., usage of the terms in sentences, paragraphs and/or phrases), etc. The document may comprise text from at least one of one or more articles, one or more social media posts, one or more blogs, documentation, one or more webpages, one or more glossaries, one or more dictionaries, etc. related to the telecommunication service provider and/or telecommunication services.

In some examples, the set of documents 103 may comprise a set of general-language context documents (e.g., a set of one or more general-language context documents). In some examples, content of the one or more second corpora may not be specific to the field. The one or more second corpora may comprise at least one of articles (e.g., news articles, encyclopedia articles, etc.), social media posts and/or blogs, webpages, a glossary, a dictionary, etc. In an example, the one or more second corpora may comprise at least one of an online encyclopedia corpus, a news language corpus, etc. The one or more second corpora may comprise text comprising usage of a language (e.g., English) in general language context and/or not specific to the field associated with the one or more first corpora. In an example, a processor may be used to read memory on which content (e.g., general language content, such as at least one of articles, social media posts, blogs, documentation, webpages, a glossary, a dictionary, etc.) is stored and/or the processor may be used to extract text from the content and/or store the text in a data store on which the one or more second corpora are stored.

In some examples, the system 101 may (i) transcribe an audio file to generate text (e.g., a transcription) indicative of speech spoken in the audio file, and/or (ii) generate a document (e.g., a field-related document, a general-language context document, etc.) of the set of documents 103 to comprise the text. Alternatively and/or additionally, the system 101 may (i) transcribe a video to generate text (e.g., a transcription) indicative of speech spoken in the video, and/or (ii) generate a document (e.g., a field-related document, a general-language context document, etc.) of the set of documents 103 to comprise the text. Alternatively and/or additionally, the system 101 may (i) analyze a video to generate text describing one or more objects and/or events depicted in the video, and/or (ii) generate a document (e.g., a field-related document, a general-language context document, etc.) of the set of documents 103 to comprise the text. Alternatively and/or additionally, the system 101 may (i) analyze an image to generate text describing one or more objects and/or events depicted in the image, and/or (ii) generate a document (e.g., a field-related document, a general-language context document, etc.) of the set of documents 103 to comprise the text.

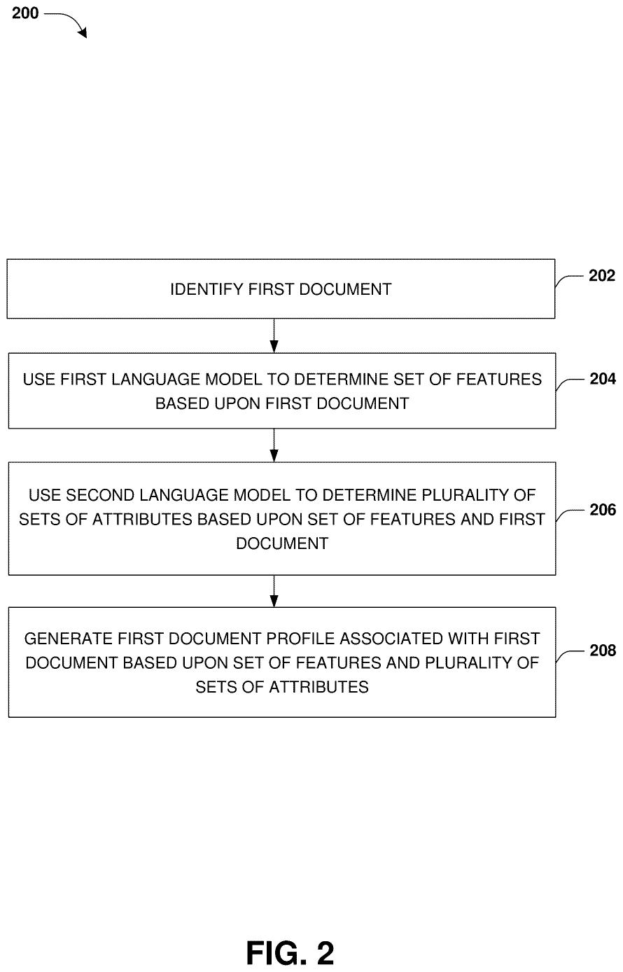

In some examples, the set of document profiles of the profile data 107 may comprise at least one of a first document profile 109 associated with the first document 102, a second document profile associated with the second document, etc. An embodiment of generating the first document profile 109 is illustrated by an exemplary method 200 of FIG. 2, and is further described in conjunction with the system 101 of FIGS. 1A-1F. At 202, the system 101 may identify the first document 102 (and/or other documents of the set of documents 103).

In some examples, one or more documents (e.g., at least one of the first document 102, the second document, etc.) of the set of documents 103 is received by the system 101 from an agent (e.g., a person, a computer, etc.) tasked with gathering and/or providing documents for use in supplementing a knowledge base of a language model (e.g., fourth language model 121) of the system 101 and/or training the language model. In some examples, the system 101 may (i) automatically access one or more internet resources (e.g., websites, applications, content platforms, etc.), (ii) extract content (e.g., text, video, audio, etc.) from the one or more internet resources, and/or (iii) generate the set of documents 103 based upon the content. A document of the set of documents 103 may comprise content extracted from an internet resource of the one or more internet resources. A document of the set of documents 103 may comprise a transcription of audio and/or video extracted from an internet resource of the one or more internet resources.

In some examples, the system 101 comprises a network monitoring tool to monitor network activity associated with one or more network elements (e.g., one or more base stations, one or more base station components, one or more radios, one or more client devices, etc.). In some examples, one or more documents (e.g., at least one of the first document 102, the second document, etc.) of the set of documents 103 comprise one or more captured data packet files indicative of one or more data packets that are intercepted and/or saved by the network monitoring tool (using one or more packet capture (PCAP) techniques, for example). In some examples, a captured data packet file of the one or more captured data packet files is indicative of at least one of (i) a source identifier (e.g., source Internet Protocol (IP) address) associated with a source of a data packet, (ii) a destination identifier (e.g., destination IP address) associated with a destination of the data packet, (iii) a payload of the data packet, (iv) one or more network elements that forwarded the data packet (from the source to the destination, for example), (v) a protocol associated with the data packet and/or (vi) other information associated with the data packet.

In some examples, one or more documents (e.g., at least one of the first document 102, the second document, etc.) of the set of documents 103 comprise one or more calls (e.g., end-to-end calls) that are intercepted and/or saved by the network monitoring tool. In some examples, one or more documents (e.g., at least one of the first document 102, the second document, etc.) of the set of documents 103 comprise one or more alarm files indicative of one or more triggered alarms that are detected by the network monitoring tool. In some examples, an alarm file of the one or more alarm files is indicative of an error, a warning and/or other information associated with one or more network elements.

In some examples, the network monitoring tool is configured to (i) detect network activity associated with the one or more network elements, and/or (ii) generate one or more documents (e.g., at least one of the first document 102, the second document, etc.) of the set of documents 103 to be indicative of the network activity and/or one or more performance metrics (e.g., at least one of bandwidth usage, packet loss, throughput, etc.) associated with the network activity.

In some examples, one or more documents (e.g., at least one of the first document 102, the second document, etc.) of the set of documents 103 comprise one or more methods of procedure (MOP) documents associated with one or more network elements. In some examples, a MOP document associated with a network element may be indicative of one or more procedures and/or guidelines for configuring and/or installing the network element and/or for performing maintenance, upgrades, configuration changes and/or troubleshooting tasks associated with the network element.

In some examples, one or more documents (e.g., at least one of the first document 102, the second document, etc.) of the set of documents 103 comprise one or more Customer Information Questionnaire (CQ) documents. In some examples, a CQ document may be indicative of details, plans, preferences and/or technical specifications provided by an entity (e.g., a customer of the telecommunication service provider) to guide configuration, deployment and/or optimization of a service and/or system (e.g., a telecommunication service provided by the telecommunication service provider).

In some examples, one or more documents (e.g., at least one of the first document 102, the second document, etc.) of the set of documents 103 comprise at least one of customer plans, tickets, design documents for networks, configurations, logs, etc.

At 204, the document profile determination module 105 may use a first language model to determine a first set of features based upon the first document 102. For example, the document profile determination module 105 may submit a first prompt to the first language model. The first prompt may comprise (i) a first set of instructions (e.g., a first set of one or more instructions) and/or (ii) one or more documents (e.g., at least one of the first document 102, the second document, etc.) comprising one, some and/or all of the set of documents 103. The first language model may generate feature data associated with the set of documents 103 in response to the first prompt. The feature data may be indicative of the first set of features associated with the first document 102. In some examples, the feature data may be indicative of a plurality of sets of features associated with documents of the set of documents 103. The plurality of sets of features may comprise the first set of features associated with the first document 102, a second set of features associated with the second document, etc. In some examples, features of the first set of features may be unique (e.g., the features may be different than each other).

In some examples, the first set of instructions instructs the first language model to identify key features (e.g., salient features) in a given document (e.g., at least one of the first document 102, the second document, etc.) of the set of documents 103. For example, the first language model may include a feature in the first set of features based upon a determination that the feature is a key feature and/or salient feature of the first document 102. Alternatively and/or additionally, the second language model may include a feature in the second set of features based upon a determination that the feature is a key feature and/or salient feature of the second document.

The set of documents 103 comprises N documents comprising Document #1 (e.g., the first document 102), Document #2 (e.g., the second document), Document #3, . . . , Document #N. In some examples, the first set of instructions may comprise feature identification instructions that instruct the first language model to (i) analyze Document #1 (e.g., the first document 102) of the set of documents 103 to identify a set of features (e.g., key and/or salient features) of Document #1, (ii) save the set of features (e.g., the first set of features) as ∀_{1-I} F₁ᵢ, wherein I may correspond a number of features for Document #1 (e.g., a number of features of the set of features), and/or (iii) perform iterations of acts (i) and (ii) for each document of a set of remaining documents (e.g., Document #2, Document #3, . . . , Document #N). In some examples, the feature identification instructions cause the first language model to determine the plurality of sets of features associated with the set of documents 103. In some examples, the plurality of sets of features may be defined as [symbol] ={F₁, F₂, . . . F_{N}}, where Fᵢ is the set of features for Document i.

In some examples, the first set of instructions may comprise common feature identification instructions that instruct the first language model to determine a set of common (and/or standardized) features associated with the set of documents. In some examples, in response to determining the plurality of sets of features (e.g., [symbol] ={F₁, F₂, . . . F_{N}}), the first language model executes the common feature identification instructions to determine the set of common features. In some examples, a feature may be included in the set of common features based upon a determination that each set of features of all of the plurality of sets of features includes the feature and/or includes a matching feature that is determined to match the feature (e.g., a feature “Author's Name” may be determined to match feature “Author”). Alternatively and/or additionally, a feature may be included in the set of common features based upon a determination that each set of features of at least a threshold proportion of the plurality of sets of features includes the feature and/or includes a matching feature that is determined to match the feature. In an example in which the threshold proportion is 80% and the plurality of sets of features comprises 10 sets of features (associated with 10 documents of the set of documents 103, for example), a feature may be included in the set of common features based upon a determination that at least eight sets of features (associated with at least eight of the 10 documents) among the plurality of sets of features includes the feature and/or includes a matching feature that is determined to match the feature. In some examples, the feature data may be indicative of the set of common features associated with the set of documents.

At 206, the document profile determination module 105 may use a second language model to determine a first plurality of sets of attributes based upon the first set of features and the first document 102. For example, the document profile determination module 105 may submit a second prompt to the second language model. The second prompt may comprise (i) a second set of instructions (e.g., a second set of one or more instructions), (ii) at least some of the feature data (e.g., the plurality of sets of features associated with the set of documents 103 and/or the set of common features), and/or (iii) one or more documents (e.g., at least one of the first document 102, the second document, etc.) comprising one, some and/or all of the set of documents 103. The second language model may generate attribute data associated with the set of documents 103 in response to the second prompt. For each document of one, some and/or all of the set of documents 103, the attribute data may comprise a plurality of sets of attributes associated with the document and/or a set of features (indicated by the feature data, for example) associated with the document. For example, the attribute data comprise at least one of (i) the first plurality of sets of attributes associated with the first document 102 and/or the first set of features, (ii) a second plurality of sets of attributes associated with the second document and/or the second set of features, etc.

In some examples, the second set of instructions instructs the second language model to identify attributes (e.g., feature categories) associated with a feature (e.g., at least one of a feature of the first set of features, a feature of the second set of features, etc.) associated with a given document (e.g., at least one of the first document 102, the second document, etc.) of the set of documents 103. For example, the second set of instructions may comprise an instruction that, for each feature of one, some and/or all of the first set of features, the second language model analyze the first document 102 to determine a set of attributes (e.g., feature categories) that (i) are relevant to (and/or describe) the feature, and/or (ii) are indicated by the first document 102. Based upon the second set of instructions, the second language model may (i) analyze the first document 102 based upon a first feature of the set of features to determine a first set of attributes (to be included in the first plurality of sets of attributes) associated with the first feature, (ii) analyze the first document 102 based upon a second feature of the set of features to determine a second set of attributes (to be included in the first plurality of sets of attributes) associated with the second feature, and/or (iii) analyze the first document 102 based upon other features of the first set of features to determine other sets of attributes (to be included in the first plurality of sets of attributes) associated with the other features. In some examples, attributes of the first set of attributes may be unique (e.g., the attributes may be different than each other).

In some examples, the second language model may include an attribute in the first set of attributes based upon a determination that (i) the attribute is relevant to the first feature (e.g., the attribute is a sub-category of the first feature), and/or (ii) the attribute is indicated by the first document 102 (e.g., the first document 102 comprises one or more terms indicative of the attribute). Alternatively and/or additionally, the second language model may include an attribute in the second set of attributes based upon a determination that (i) the attribute is relevant to the second feature (e.g., the attribute is a sub-category of the second feature), and/or (ii) the attribute is indicated by the first document 102 (e.g., the first document 102 comprises one or more terms indicative of the attribute).

In some examples, the second plurality of sets of attributes (associated with the second document and/or the second set of features) comprises (i) a third set of attributes associated with a third feature of the second set of features (e.g., the third set of attributes may correspond to feature categories at are relevant to and/or that describe the third feature), (ii) a fourth set of attributes associated with a fourth feature of the second set of features (e.g., the fourth set of attributes may correspond to feature categories at are relevant to and/or that describe the fourth feature), and/or (iii) one or more other sets of attributes associated with one or more other features of the second set of features.

In some examples, the second language model may be configured to at least one of standardize, normalize, harmonize, etc. the attribute data. For example, the second set of instructions may instruct the second language model to analyze the set of documents 103 to identify (e.g., extract) attributes associated with the set of documents 103 (e.g., the second language model may be prompted to extract attributes from each document of one, some and/or all of the set of documents 103). The attributes may be aggregated according to feature and/or document to generate an initial version of the attribute data (e.g., the attributes may be grouped into different sets of attributes by feature and/or document). The initial version of the attribute data may be indicative of an initial version of the first plurality of sets of attributes associated with the first document 102, an initial version of the second plurality of sets of attributes associated with the second document, etc. The initial version of the first plurality of sets of attributes may comprise an initial version of the first set of attributes (associated with the first feature and/or the first document 102), an initial version of the second set of attributes (associated with the second feature and/or the first document 102), etc. The initial version of the second plurality of sets of attributes may comprise an initial version of the third set of attributes (associated with the third feature and/or the second document), an initial version of the fourth set of attributes (associated with the fourth feature and/or the second document), etc.

In some examples, the second language model may be configured to modify the initial version of the attribute data to generate an updated version of the attribute data (e.g., a standardized, normalized, harmonized, etc. version of the attribute data) associated with the set of documents 103. In some examples, the second set of instructions may instruct the second language model to (i) summarize the initial version of the attribute data to generate summarized attribute data and/or (ii) extract, from the summarized attribute data, a set of standardized attributes per feature for each document of one, some and/or all of the set of documents 103 to generate the updated version of the attribute data. In an example, for each document of one, some and/or all of the set of documents 103, the second language model may re-apply the second prompt or apply a different prompt to extract a set of standardized attributes per feature per document. The updated version of the attribute data may be indicative of an updated version (e.g., standardized version) of the first plurality of sets of attributes comprising at least one of an updated version (e.g., standardized version) of first set of attributes (associated with the first feature and/or the first document 102), an updated version (e.g., standardized version) of the second set of attributes (associated with the second feature and/or the first document 102), etc. The updated version of the attribute data may be indicative of an updated version (e.g., standardized version) of the second plurality of sets of attributes comprising at least one of an updated version (e.g., standardized version) of the third set of attributes (associated with the third feature and/or the second document), an updated version (e.g., standardized version) of the fourth set of attributes (associated with the fourth feature and/or the second document), etc.

In some examples, the second language model may identify one or more redundant attributes in a set of attributes of the initial version of the attribute data, and/or may remove one or more of the redundant attributes (and/or may replace the redundant attributes with a single attribute) to generate an updated set of attributes of the updated version of the attribute data. In an example, the second language model may determine that two or more attributes of the initial version of the first set of attributes (associated with the first feature and/or the first document 102) are redundant. For example, the redundant attributes of the first set of attributes may comprise an attribute indicative of “First Name” and an attribute indicative of “Given Name”. In response to identifying the redundant attributes, the second language model may remove the attribute indicative of “Given Name” to generate the updated version of the first set of attributes comprising the attribute indicative of “First Name” without the (redundant) attribute indicative of “Given Name”.

In some examples, the second language model may make modifications to the initial version of the attribute data to improve data consistency (e.g., consistent labeling of attributes) of the updated version of the attribute data across different sets of attributes associated with different features and/or documents. For example, the second language model may identify a labeling inconsistency between the first set of attributes (associated with the first feature and/or the first document 102) and the initial version of the third set of attributes (associated with the third feature and/or the second document). For example, the first set of attributes may comprise an attribute indicative of “First Name” while the third set of attributes may comprise an attribute indicative of “Given Name”. The attribute indicative of “First Name” and the attribute indicative of “Given Name” correspond to a single entity (e.g., a first name of a person). The second language model may replace the attribute indicative of “Given Name” in the initial version of the third set of attributes with an attribute indicative of “First Name” in the updated version of the third set of attributes such that the updated version of the third set of attributes is more consistent with the updated version of the first set of attributes.

At 208, the document profile determination module 105 may generate the first document profile 109 associated with the first document 102 based upon the first set of features and the first plurality of sets of attributes (e.g., the updated version of the first plurality of sets of attributes). For example, the first document profile 109 may be indicative of the first set of features associated with the first document 102 and the first plurality of sets of attributes (e.g., the updated version of the first plurality of sets of attributes) associated with the first set of features and the first document 102. In some examples, the document profile determination module 105 may be configured to determine keywords associated with attributes of the first plurality of sets of attributes, and/or may generate the first document profile 109 to be indicative of the keywords. In some examples, keywords of the first set of keywords may be unique (e.g., the keywords may be different than each other).

For example, the document profile determination module 105 may use a third language model to determine a first plurality of sets of keywords based upon the first plurality of sets of attributes and the first document 102. For example, the document profile determination module 105 may submit a third prompt to the third language model. The third prompt may comprise (i) a third set of instructions (e.g., a third set of one or more instructions), (ii) at least some of the feature data and/or the attribute data (e.g., the updated version of the attribute data comprising at least one of the first plurality of sets of attributes associated with the first document 102, the second plurality of sets of attributes associated with the second document, etc.), and/or (iii) one or more documents (e.g., at least one of the first document 102, the second document, etc.) comprising one, some and/or all of the set of documents 103. The third language model may generate keyword data associated with the set of documents 103 in response to the third prompt. For each document of one, some and/or all of the set of documents 103, the keyword data may comprise a plurality of sets of keywords associated with the document and/or attributes (indicated by the attribute data, for example) associated with the document. For example, the keyword data comprise at least one of (i) the first plurality of sets of keywords associated with the first document 102 and/or the first plurality of sets of attributes, (ii) a second plurality of sets of keywords associated with the second document and/or the second plurality of sets of attributes, etc.

In some examples, the third set of instructions instructs the third language model to identify keywords (e.g., attribute categories) associated with an attribute (e.g., at least one of an attribute of the first plurality of sets of attributes, an attribute of the second plurality of sets of attributes, etc.) associated with a given document (e.g., at least one of the first document 102, the second document, etc.) of the set of documents 103. For example, the third set of instructions may comprise an instruction that, for each attribute of one, some and/or all of the first plurality of sets of attributes, the third language model analyze the first document 102 to determine a set of keywords (e.g., attribute categories) that (i) are relevant to (and/or define) the attribute, and/or (ii) are indicated by the first document 102. Based upon the third set of instructions, the third language model may (i) analyze the first document 102 based upon a first attribute of the first plurality of sets of attributes to determine a first set of keywords (to be included in the first plurality of sets of keywords) associated with the first attribute, (ii) analyze the first document 102 based upon a second attribute of the first plurality of sets of attributes to determine a second set of keywords (to be included in the first plurality of sets of keywords) associated with the second attribute, and/or (iii) analyze the first document 102 based upon other attributes of the first plurality of sets of attributes to determine other sets of keywords (to be included in the first plurality of sets of keywords) associated with the other attributes.

In some examples, the third language model may include a keyword in the first set of keywords based upon a determination that (i) the keyword is relevant to the first attribute (e.g., the keyword is a sub-category of the first attribute), and/or (ii) the keyword is indicated by the first document 102 (e.g., the first document 102 comprises one or more terms indicative of the keyword). Alternatively and/or additionally, the third language model may include a keyword in the second set of keywords based upon a determination that (i) the keyword is relevant to the second attribute (e.g., the keyword is a sub-category of the second attribute), and/or (ii) the keyword is indicated by the first document 102 (e.g., the first document 102 comprises one or more terms indicative of the keyword).

In some examples, the second plurality of sets of keywords (associated with the second document and/or the second plurality of sets of attributes) comprises (i) a third set of keywords associated with a third attribute of the second plurality of sets of attributes (e.g., the third set of keywords may correspond to attribute categories that are relevant to and/or that define the third attribute), (ii) a fourth set of keywords associated with a fourth attribute of the second plurality of sets of attributes (e.g., the fourth set of keywords may correspond to attribute categories that are relevant to and/or that define the fourth attribute), and/or (iii) one or more other sets of keywords associated with one or more other attributes of the second plurality of sets of attributes.

In some examples, the third language model may be configured to at least one of standardize, normalize, harmonize, etc. the keyword data. For example, the third set of instructions may instruct the third language model to analyze the set of documents 103 to identify (e.g., extract) keywords associated with the set of documents 103 (e.g., the third language model may be prompted to extract keywords from each document of one, some and/or all of the set of documents 103). The keywords may be aggregated according to attribute and/or document to generate an initial version of the keyword data (e.g., the keywords may be grouped into different sets of keywords by attribute and/or document). The initial version of the keyword data may be indicative of an initial version of the first plurality of sets of keywords associated with the first document 102, an initial version of the second plurality of sets of keywords associated with the second document, etc. The initial version of the first plurality of sets of keywords may comprise an initial version of the first set of keywords (associated with the first attribute and/or the first document 102), an initial version of the second set of keywords (associated with the second attribute and/or the first document 102), etc. The initial version of the second plurality of sets of keywords may comprise an initial version of the third set of keywords (associated with the third attribute and/or the second document), an initial version of the fourth set of keywords (associated with the fourth attribute and/or the second document), etc.

In some examples, the third language model may be configured to modify the initial version of the keyword data to generate an updated version of the keyword data (e.g., a standardized, normalized, harmonized, etc. version of the keyword data) associated with the set of documents 103. In some examples, the third set of instructions may instruct the third language model to (i) summarize the initial version of the keyword data to generate summarized keyword data and/or (ii) extract, from the summarized keyword data, a set of standardized keywords per attribute for each document of one, some and/or all of the set of documents 103 to generate the updated version of the keyword data. In an example, for each document of one, some and/or all of the set of documents 103, the third language model may re-apply the third prompt or apply a different prompt to extract a set of standardized keywords per attribute per document. The updated version of the keyword data may be indicative of an updated version (e.g., standardized version) of the first plurality of sets of keywords comprising at least one of an updated version (e.g., standardized version) of first set of keywords (associated with the first attribute and/or the first document 102), an updated version (e.g., standardized version) of the second set of keywords (associated with the second attribute and/or the first document 102), etc. The updated version of the keyword data may be indicative of an updated version (e.g., standardized version) of the second plurality of sets of keywords comprising at least one of an updated version (e.g., standardized version) of the third set of keywords (associated with the third attribute and/or the second document), an updated version (e.g., standardized version) of the fourth set of keywords (associated with the fourth attribute and/or the second document), etc.

In some examples, the third language model may identify one or more redundant keywords in a set of keywords of the initial version of the keyword data, and/or may remove one or more of the redundant keywords (and/or may replace the redundant keywords with a single keyword) to generate an updated set of keywords of the updated version of the keyword data. In an example, the third language model may determine that two or more keywords of the initial version of the first set of keywords (associated with the first attribute and/or the first document 102) are redundant. For example, the redundant keywords of the first set of keywords may comprise a keyword indicative of “4G” and a keyword indicative of “fourth generation”. In response to identifying the redundant keywords, the third language model may remove the keyword indicative of “fourth generation” to generate the updated version of the first set of keywords comprising the keyword indicative of “4G” without the (redundant) keyword indicative of “fourth generation”.

In some examples, the third language model may make modifications to the initial version of the keyword data to improve data consistency (e.g., consistent labeling of keywords) of the updated version of the keyword data across different sets of keywords associated with different attributes and/or documents. For example, the third language model may identify a labeling inconsistency between the first set of keywords (associated with the first attribute and/or the first document 102) and the initial version of the third set of keywords (associated with the third attribute and/or the second document). For example, the first set of keywords may comprise a keyword indicative of “4G” while the third set of keywords may comprise a keyword indicative of “fourth generation”. The keyword indicative of “4G” and the keyword indicative of “fourth generation” correspond to a single entity (e.g., a wireless technology). The third language model may replace the keyword indicative of “fourth generation” in the initial version of the third set of keywords with a keyword indicative of “4G” in the updated version of the third set of keywords such that the updated version of the third set of keywords is more consistent with the updated version of the first set of keywords.

In some examples, the document profile determination module 105 may generate the first document profile 109 associated with the first document 102 based upon the first plurality of sets of keywords (e.g., the updated version of the first plurality of sets of keywords). For example, the first document profile 109 may be indicative of the first set of features, the first plurality of sets of attributes (e.g., the updated version of the first plurality of sets of attributes) and/or the first plurality of sets of keywords (e.g., the updated version of the first plurality of sets of keywords).

FIG. 1B illustrates an example representation 110 of the first document profile 109 associated with the first document. The first document profile 109 may be indicative of features 132 (e.g., the first set of features), attributes 134 (e.g., the updated version of the first plurality of sets of attributes) and/or keywords 136 (e.g., the updated version of the first plurality of sets of keywords). For example, the features 132 may comprise Feature 1 indicative of “Document Name”, Feature 2 indicative of “Author's Name” and/or Feature 3 indicative of “Domain”. The attributes 134 may comprise a set of attributes 114 (e.g., the updated version of the first set of attributes) associated with Feature 2 and a set of attributes 116 (e.g., the updated version of the second set of attributes) associated with Feature 3. The set of attributes 114 may comprise Attribute 1 indicative of “First Name” and/or Attribute 2 indicative of “Last Name”. The set of attributes 116 may comprise Attribute A indicative of “Wireless” and/or Attribute B indicative of “Wireline”. The keywords 136 may comprise a set of keywords 118 (e.g., the updated version of the first set of keywords) associated with Attribute A of the set of attributes 116 and a set of keywords 120 (e.g., the updated version of the second set of keywords) associated with Attribute B of the set of attributes 116. The set of keywords 118 may comprise 4G, 5G, RAN, SMF, AMF, and/or Router. The set of keywords 120 may comprise Router, Switch and/or FIOS. As shown in the example representation 110 of FIG. 1B, different sets of keywords associated with different attributes may share the same keyword (e.g., the set of keywords 118 associated with Attribute A and the set of keywords 120 associated with Attribute B both comprise “Router” as a keyword). Embodiments are contemplated in which different sets of attributes associated with different features may share the same attribute.

Other document profiles of the set of document profiles of the profile data 107 other than the first document profile 109 may be generated (automatically and/or without manual user intervention) using one some and/or all of the techniques provided herein with respect to generating the first document profile 109. In an example, the second document profile may be indicative of the second set of features, the second plurality of sets of attributes (e.g., the updated version of the second plurality of sets of attributes) and/or the second plurality of sets of keywords (e.g., the updated version of the second plurality of sets of keywords). Thus, each document profile of one, some and/or all of the set of document profiles may be indicative of features, attributes, and/or keywords of a document and/or their interrelationships to each other. The content generation system 115 may use document profiles of the profile data 107 to accurately and/or efficiently retrieve relevant documents (among the set of documents 103, for example) for generating responses to queries.

FIG. 1C illustrates the messaging interface 142 displayed via a first client device 100 (e.g., a phone, a laptop, a computer, a wearable device, a smart device, a television, user equipment (UE), any other type of computing device, hardware, etc.) associated with the first user. The messaging interface 142 (e.g., a chatbot messaging interface 142) may be used for receiving one or more messages input via the first client device 100. A message may be input by the first user by typing the message into the messaging interface 142 using a keyboard (e.g., at least one of a physical keyboard, a touchscreen keyboard, etc.). Alternatively and/or additionally, a voice recognition system may be used to convert audible speech recorded by the first client device 100 into a set of text. In an example, communication over the messaging interface 142 may be performed using a computer communications protocol that provides one or more communication channels over a connection.

In some examples, in response to detecting text input via the messaging interface 142, one or more messages may be suggested (e.g., auto-suggested) via the messaging interface 142 (e.g., the one or more messages may be determined via one or more predictive text techniques, and/or a message of the one or more messages may be selected via the messaging interface 142). In response to receiving a message input via the messaging interface 142, the content generation system 115 may be used to generate a response to the message.

In an example, in FIG. 1C, a first message 144 generated by the chatbot system (e.g., generated by the communication system) may be transmitted to the first client device 100 and/or displayed via the messaging interface 142 (e.g., the first message 144 may be displayed as a starting message of a conversation between the first user and the chatbot system). A second message 146, indicative of the query 113, may be received from the first client device 100 via the messaging interface 142. The query 113 may correspond to a request for a service, such as a request to generate content (e.g., formatted text and/or other content), a request for an action to be performed, etc. In the example shown in FIG. 1C, the query 113 comprises “In the context of wireless communication, please compare AMF operation in 5G versus MMF operation in 4G and give me a summary of their differences.” and corresponds to a request for the content generation system 115 to generate a summary of difference between technologies (e.g., Access and Mobility Management Function (AMF) associated with 5G and Mobility Management Function (MMF) associated with 4G).

The content generation system 115 may generate the response 123 based upon the query 113 and document profiles of the document profile data store 111. For example, the content generation system 115 may comprise a relevant document retrieval module 117 that is configured to use document profiles of the document profile data store 111 to identify a set of relevant documents 119 (e.g., a set of one or more relevant documents) for use in generating the response 123. For example, the document profile data store 111 may comprise a plurality of document profiles associated with a plurality of documents. The plurality of document profiles may comprise the set of document profiles of the profile data 107 and/or other document profiles associated with other documents. The plurality of documents may comprise the set of documents 103 and/or other documents. The relevant document retrieval module 117 may select the set of relevant documents 119 from the plurality of documents.

In an example, the relevant document retrieval module 117 may include the first document 102 in the set of relevant documents in response to determining, based upon the first document profile 109 and the query 113, that the first document 102 is relevant to the query 113. In an example, the relevant document retrieval module 117 may determine that the first document 102 is relevant to the query 113 (and thus may include the first document 102 in the set of relevant documents, for example) based upon a determination that at least a portion of the query 113 matches (e.g., is indicative of and/or similar to) a feature, an attribute, and/or a keyword indicated by the first document profile 109.

For example, the relevant document retrieval module 117 may determine that the first document 102 is relevant to the query 113 (and thus may include the first document 102 in the set of relevant documents 119, for example) based upon (i) a determination that that keyword “4G” of the first set of keywords 118 matches “4G” in the query 113, (ii) a determination that that keyword “5G” of the set of keywords 118 matches “5G” in the query 113, (iii) a determination that that keyword “AMF” of the set of keywords 118 matches “AMF” in the query 113, and/or (iv) a determination that that the Attribute A indicative of “Wireless” matches “wireless” in the query 113.

In some examples, the relevant document retrieval module 117 may provide the set of relevant documents 119 to a fourth language model 121 of the content generation system 115. The fourth language model 121 may generate the response 123 based upon the set of relevant documents 119 and the query 113. FIG. 1D illustrates a third message 148 comprising the response 123 being transmitted by the content generation system 115 to the first client device 100. FIG. 1E illustrates the third message 148 displayed via the messaging interface 142.

The query 113 may comprise a request for network information associated with the telecommunication service provider. Alternatively and/or additionally, the set of document profiles of the profile data 107 may be used for determining the information associated with the telecommunication service provider. In an example, the query 113 may comprise “which base station in Ohio had the most traffic last month?”. The content generation system 115 may (i) evaluate document profiles of the plurality of document profiles to identify documents (e.g., data packet files and/or other documents) associated with base stations in Ohio, (ii) include the identified documents in the set of relevant documents 119, and/or (iii) generate the response 123 to comprise an indication of a base station determined to have had a greatest amount of traffic among the base stations.

In an example, the query 113 may comprise “which protocol has seen the most errors this week?”. The content generation system 115 may (i) evaluate document profiles of the plurality of document profiles to group documents (e.g., data packet files, alarm files, and/or other documents) into a plurality of groups of documents associated with a plurality of protocols, (ii) include the plurality of groups of documents in the set of relevant documents 119, (iii) determine, based upon the plurality of groups of documents, error rates associated with the plurality of protocols, and/or (iv) generate, based upon the error rates, the response 123 to comprise an indication of a protocol associated with a highest error rate among the error rates.

In an example, the query 113 may comprise “which error was most common this week?”. The system 101 may (i) use the relevant document retrieval module 117 to evaluate document profiles of the plurality of document profiles to group documents (e.g., data packet files, alarm files, and/or other documents) into a plurality of groups of documents associated with a plurality of error types, (ii) include the plurality of groups of documents in the set of relevant documents 119, (iii) determine, based upon the plurality of groups of documents, error rates associated with the plurality of error types, and/or (iv) generate, based upon the error rates, the response 123 to comprise an indication of an error type associated with a highest error rate among the error rates.

It may be appreciated that determining the set of relevant documents 119 (and/or filtering out documents that are irrelevant to the query 113 from the set of relevant documents 119) and providing the set of relevant documents 119 to the fourth language model 121 for use in generating the response 123 enables the response 123 to be generated (using one or more generative artificial intelligence (AI) techniques) by the fourth language model 121 more efficiently (e.g., the response 123 may be generated with fewer computational resources as a result of processing less data by filtering out documents that are not relevant to the query 113), in comparison with some systems that do not provide relevant documents (and/or filter out irrelevant documents) to a language model for use in responding to queries.

In some examples, at least some of the present disclosure may be performed and/or implemented automatically and/or in real time. For example, at least some of the present disclosure may be performed and/or implemented such that communication between the first user and the chatbot system is performed quickly (e.g., instantly) and/or in real time. In an example, at least some operations provided herein (e.g., at least one of determining the set of relevant documents 119, generating the response 123, etc.) may be performed automatically and/or in real time in response to (e.g., upon) reception of the query 113 via the messaging interface 142. In some examples, at least some of the operations may be performed using the first client device 100 (e.g., a processor of the first client device 100 may perform at least some of the operations using a program installed on the first client device 100). Alternatively and/or additionally, at least some of the operations may be performed using a computer (e.g., a server hosting an application providing generative AI services) that may be connected to the first client device 100 via one or more networks (and/or the Internet).

In some examples, the first language model, the second language model, the third language model and/or the fourth language model 121 may be the same language model or may be different language models. For example, the first language model may be the same as or different than the second language model, the first language model may be the same as or different than the third language model, the first language model may be the same as or different than the fourth language model 121, the second language model may be the same as or different than the third language model, the second language model may be the same as or different than the fourth language model 121, and/or the third language model may be the same as or different than the fourth language model 121.

Implementation of at least some of the disclosed subject matter may lead to benefits including, but not limited to, reduced (and/or zero) manual effort in comparison with some manual metadata creation techniques that rely on one or more people to manually create metadata for documents. In accordance with some of the techniques provided herein, the system 101 may automatically generate metadata (e.g., the profile data 107 and/or the set of document profiles) that may be descriptive of documents (e.g., the set of documents 103 and/or documents for which metadata is not available, for example) and/or usable to quickly identify relevant documents.

Implementation of at least some of the disclosed subject matter may lead to benefits including, but not limited to, more accurate and/or appropriate response to a message received from a client device, wherein the response has a higher probability of being desired and/or intended by a user of the client device. Alternatively and/or additionally, implementation of at least some of the disclosed subject matter may lead to benefits including a reduction in screen space and/or an improved usability of a display (e.g., of the client device) (e.g., as a result of the higher probability of the response being desired by the user, wherein the user may not need to open a separate application and/or a separate window to find the desired response).

In some examples, a first set of operations may be executed based upon the first document profile 109 (and/or other document profiles of the document profile data store 111) to perform a first network action. In some examples, the first network action may be associated with a first network element. The first network element may comprise at least one of a base station, a base station component, an antenna, a radio, a client device, etc. The query 113 may be indicative of a request to perform the first network action associated with the first network element. In an example, the first network action may comprise (i) configuring and/or installing the first network element in a network, (ii) performing maintenance on the first network element, (iii) performing an upgrade, a configuration change and/or a troubleshooting task associated with the first network element, (iv) adjusting (e.g., decreasing or increasing) a network parameter (e.g., a transmission power, frequency channel, antenna tilt, azimuth, etc.) associated with the first network element and/or (iv) one or more other acts.

In some examples, the set of relevant documents 119 may include one or more first network action documents (e.g., one or more MOP documents and/or one or more CQ documents). In some examples, the relevant document retrieval module 117 includes the one or more first network action documents in the set of relevant documents 119 based upon a determination, using one or more document profiles (stored in the document profile data store 111, for example) associated with the one or more first network action documents, that the one or more first network action documents are relevant to the query 113 (and/or the first network element and/or the first network action). In some examples, the relevant document retrieval module 117 may (i) analyze the query 113 to determine the first network element and/or the first network action, and/or (ii) include the one or more first network action documents in the set of relevant documents 119 based upon a determination, using the one or more document profiles associated with the one or more first network action documents, that the one or more first network action documents are relevant to the first network element and/or the first network action.

In some examples, the content generation system 115 may use the set of relevant documents 119 to generate a first network action program 190 (shown in FIG. 1F) indicative of the first set of operations. For example, the first set of operations may comprise one or more operations (e.g., computer operations) that the content generation system 115 determines are necessary to perform the first network action in accordance with the one or more first network action documents. In an example, the content generation system 115 may determine which operations to include in the first set of operations and/or an order in which the first set of operations shall be performed using MOP and/or CQI information provided by one or more first network action documents (e.g., the one or more MOP documents and/or the one or more CIQ documents).

FIG. 1F illustrates use of the first network action program 190 to perform the first network action (shown with reference number 196) associated with the first network element (shown with reference number 198). In some examples, the system 101 may comprise a network management system 192 for managing one or more network elements of one or more networks. The first network action program 190 may be provided to the network management system 192. The network management system 192 may execute the first set of operations indicated by the first network action program 190 to perform the first network action 196 (e.g., configuring, reconfiguring and/or installing the first network element 198 in a network, performing maintenance on the first network element 198, etc.).

In some examples, each language model of one, some and/or all of the language models herein (e.g., the first language model, the second language model, the third language model, the fourth language model 121 and/or the fifth language model) may comprise a large language model and/or a generative artificial intelligence (AI) tool. Alternatively and/or additionally, each language model of one, some and/or all of the language models herein (e.g., the first language model, the second language model, the third language model, the fourth language model 121 and/or the fifth language model) may comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc.

In some examples, the system 101 may comprise an automatic self-learning module that is configured to (i) capture queries (e.g., the query 113) input to the content generation system 115, (ii) capture responses (e.g., the response 123) generated by the content generation system 115 in response to the queries, and/or (iii) make updates (e.g., adjustments and/or improvements) to one or more components of the system 101 (e.g., at least one of the document profile determination module 105, the content generation system 115, the relevant document retrieval module 117, the first language model, the second language model, the third language model, the fourth language model 121, the fifth language model, etc.) to improve accuracy and/or quality of subsequent responses generated using the system 101 (in response to subsequently received queries, for example). In some examples, the system 101 runs the automatic self-learning module in a periodic or aperiodic manner.

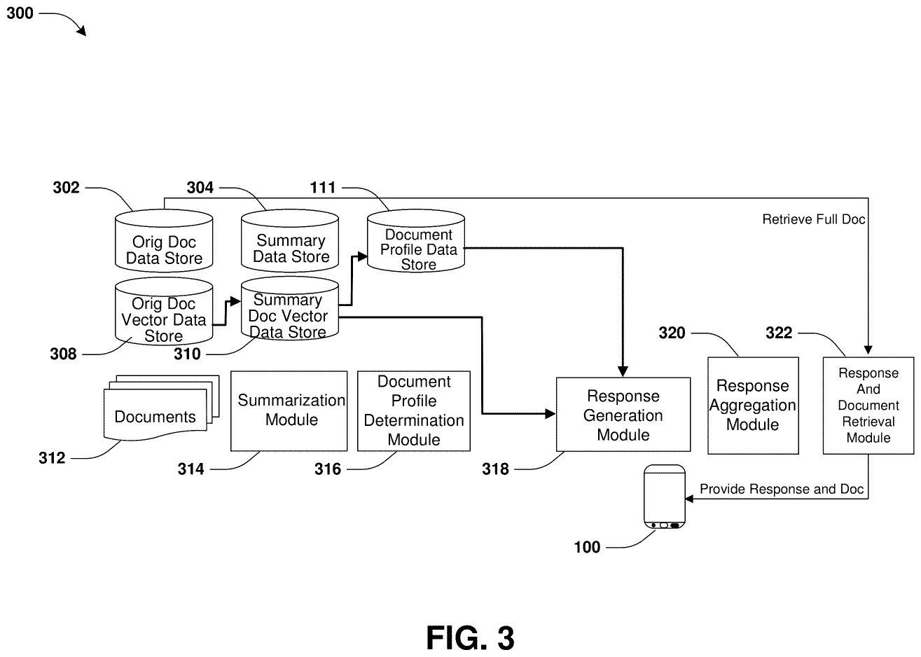

FIG. 3 illustrates an example scenario 300 implemented by the system 101. In some examples, the system 101 comprises (i) an original document data store 302 (e.g., blob storage associated with raw data) in which documents (e.g., the plurality of documents) are stored), (ii) an original document vector data store 308 (e.g., a vector database) in which vector representations of documents (e.g., the plurality of documents) are stored (e.g., the vector representations may be generated by using one or more document to vector conversion techniques to convert a document to one or more vector representations), (iii) a summary data store 304 (e.g., summary blob storage) in which summaries comprising summarized versions of documents (e.g., the plurality of documents) are stored (e.g., the summaries may be generated by summarizing the plurality of documents using at least one of the first language model, the second language model, the third language model, the fourth language model 121, the fifth language model, etc.), (iv) a summary vector data store 310 (e.g., a vector database) in which vector representations of the summaries are stored (e.g., the vector representations may be generated by using one or more document to vector conversion techniques to convert a summary to one or more vector representations), and/or (v) the document profile data store 111 for storing document profiles associated with documents (e.g., the plurality of documents).

In an example, documents 312 may identified by the system 101 (e.g., the documents 312 may comprise content automatically scraped from one or more internet resources and/or content manually provided by a user) may be stored in the original document data store 302. Vector representations of the documents 312 may be generated and/or stored in the original document vector data store 308. The documents 312 may be summarized by a summarization module 314 to generate summaries. The summaries may be stored in the summary data store 304. Vector representations of the summaries may be generated and/or stored in the summary vector data store 310. In some examples, the summarization module 314 may use a language model (e.g., the first language model, the second language model, the third language model, the fourth language model 121, the fifth language model and/or a different language model) to summarize the documents 312 to generate the summaries. In some examples, the document profile determination module 316 may be configured to automatically generate profile data (e.g., metadata) including document profiles (e.g., at least one of the first document profile 109, the second document profile, etc.) associated with the documents 312. The document profiles may be stored in the document profile data store 111. In an example, the document profile data store 111 may comprise a metadata database implemented by Structured Query Language (SQL) and/or one or more other data management languages.

In some examples, in response to receiving the query 113, a response generation module 318 of the system 101 may (i) use the content generation system 115 to generate a first response (e.g., the response 123) to the query 113 using the document profile data store 115, the original document vector data store 308 and/or the summary vector data store 310 (e.g., the first response may be generated using one, some and/or all of the techniques provided herein with respect to generating the response 123), and/or (ii) generate a second response. In some examples, the second response is generated by performing a database query (using the query 113) using the summary vector data store 310. In some examples, the first response and the second response are combined by a response aggregation module 320 of the system 101 to generate an updated response. For example, the response aggregation module 320 may use a language model (e.g., the first language model, the second language model, the third language model, the fourth language model 121, the fifth language model and/or a different language model) to generate the updated response based upon the first response and the second response. In some examples, a response and document retrieval module 322 may (i) retrieve the updated response provided by the response aggregation module 320 and/or (ii) retrieve one or more documents, from the original document data store 302, based upon which the updated response (and/or the first response and/or the second response) was generated (e.g., the one or more documents may comprise one, some and/or all of the set of relevant documents 119). The response and document retrieval module 322 may provide the updated response and the one or more documents (e.g., the set of relevant documents 119) to the first client device 100.

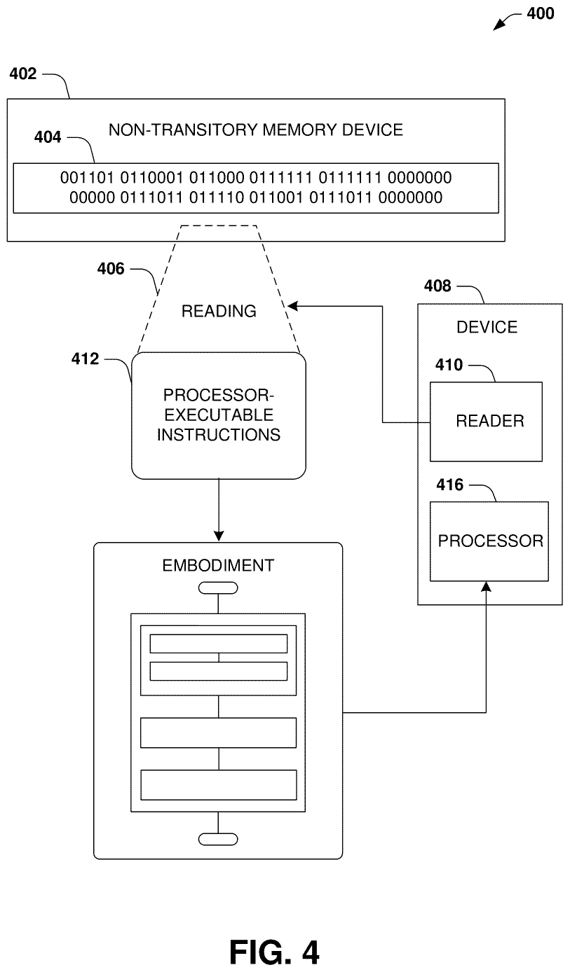

FIG. 4 is an illustration of a scenario 400 involving an example non-transitory machine readable medium 402. The non-transitory machine readable medium 402 may comprise processor-executable instructions 412 that when executed by a processor 416 cause performance (e.g., by the processor 416) of at least some of the provisions herein. The non-transitory machine readable medium 402 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 402 stores computer-readable data 404 that, when subjected to reading 406 by a reader 410 of a device 408 (e.g., a read head of a hard disk drive, or a read operation invoked on a solid-state storage device), express the processor-executable instructions 412. In some embodiments, the processor-executable instructions 412, when executed cause performance of operations, such as at least some of the example method 200 of FIG. 2, for example. In some embodiments, the processor-executable instructions 412 are configured to cause implementation of a system, such as at least some of the example system 101 of FIGS. 1A-1F, for example.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some and/or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
identifying a first document;
using a first language model to determine a set of features based upon the first document;
using a second language model to determine a plurality of sets of attributes based upon the set of features and the first document, wherein determining the plurality of sets of attributes comprises:
determining a first set of attributes associated with a first feature of the set of features based upon the first feature and the first document; and
determining a second set of attributes associated with a second feature of the set of features based upon the second feature and the first document;
generating a first document profile associated with the first document based upon the set of features and the plurality of sets of attributes; and
executing, based upon the first document profile, a set of operations to perform a network action.

2. The method of claim 1, comprising:
providing the first document profile to a retrieval augmented generation (RAG) system, wherein the RAG system generates a program indicative of the set of operations based upon a query and the first document profile.

3. The method of claim 1, comprising:
storing the first document profile in a document profile data store, wherein the document profile data store comprises a plurality of document profiles associated with a plurality of documents;
receiving, from a client device, a query for a third language model;
determining, based upon the query and document profiles of the document profile data store, a set of relevant documents among the plurality of documents; and
generating, using the third language model, a program indicative of the set of operations based upon the set of relevant documents.

4. The method of claim 3, wherein determining the set of relevant documents comprises:
including the first document in the set of relevant documents based upon a determination, based upon the first document profile and the query, that the first document is relevant to the query.

5. The method of claim 3, wherein determining the set of relevant documents comprises:
determining that the first document is relevant to the query based upon a determination that at least a portion of the query matches at least one of a feature, an attribute, or a keyword indicated by the first document profile; and
including the first document in the set of relevant documents based upon the determination that the first document is relevant to the query.

6. The method of claim 1, comprising:
using a third language model to determine a plurality of sets of keywords based upon attributes of the plurality of sets of attributes and the first document, wherein determining the plurality of sets of keywords comprises:
determining a first set of keywords associated with a first attribute of the plurality of sets of attributes based upon the first attribute and the first document; and
determining a second set of keywords associated with a second attribute of the plurality of sets of attributes based upon the second attribute and the first document.

7. The method of claim 6, wherein generating the first document profile associated with the first document is performed based upon the plurality of sets of keywords.

8. The method of claim 6, wherein:
the third language model is the same as at least one of the first language model or the second language model.

9. The method of claim 6, wherein:
the third language model is different than at least one of the first language model or the second language model.

10. A non-transitory computer-readable medium storing instructions that when executed perform operations comprising:
identifying a first document;
using a first language model to determine a set of features based upon the first document;
using a second language model to determine a plurality of sets of attributes based upon the set of features and the first document, wherein determining the plurality of sets of attributes comprises:
determining a first set of attributes associated with a first feature of the set of features based upon the first feature and the first document; and
determining a second set of attributes associated with a second feature of the set of features based upon the second feature and the first document; and
generating a first document profile associated with the first document based upon the set of features and the plurality of sets of attributes.

11. The non-transitory computer-readable medium of claim 10, the operations comprising:
providing the first document profile to a retrieval augmented generation (RAG) system, wherein the RAG system generates a response to a query based upon the first document profile.

12. The non-transitory computer-readable medium of claim 10, comprising:
storing the first document profile in a document profile data store, wherein the document profile data store comprises a plurality of document profiles associated with a plurality of documents;
receiving, from a client device, a query for a third language model;
determining, based upon the query and document profiles of the document profile data store, a set of relevant documents among the plurality of documents; and
generating, using the third language model, a response to the query based upon the set of relevant documents.

13. The non-transitory computer-readable medium of claim 12, wherein determining the set of relevant documents comprises:
including the first document in the set of relevant documents based upon a determination, based upon the first document profile and the query, that the first document is relevant to the query.

14. The non-transitory computer-readable medium of claim 12, wherein determining the set of relevant documents comprises:
determining that the first document is relevant to the query based upon a determination that at least a portion of the query matches at least one of a feature, an attribute, or a keyword indicated by the first document profile; and
including the first document in the set of relevant documents based upon the determination that the first document is relevant to the query.

15. The non-transitory computer-readable medium of claim 10, the operations comprising:
using a third language model to determine a plurality of sets of keywords based upon attributes of the plurality of sets of attributes and the first document, wherein determining the plurality of sets of keywords comprises:
determining a first set of keywords associated with a first attribute of the plurality of sets of attributes based upon the first attribute and the first document; and
determining a second set of keywords associated with a second attribute of the plurality of sets of attributes based upon the second attribute and the first document.

16. The non-transitory computer-readable medium of claim 15, wherein generating the first document profile associated with the first document is performed based upon the plurality of sets of keywords.

17. The non-transitory computer-readable medium of claim 15, wherein:
the third language model is the same as at least one of the first language model or the second language model.

18. The non-transitory computer-readable medium of claim 15, wherein:
the third language model is different than at least one of the first language model or the second language model.

19. A computer comprising:
a processor coupled to memory, the processor configured to execute instructions from the memory to perform operations comprising:
identifying a first document;
using a first language model to determine a set of features based upon the first document;
using a second language model to determine a plurality of sets of attributes based upon the set of features and the first document, wherein determining the plurality of sets of attributes comprises:
determining a first set of attributes associated with a first feature of the set of features based upon the first feature and the first document; and
determining a second set of attributes associated with a second feature of the set of features based upon the second feature and the first document; and
generating a first document profile associated with the first document based upon the set of features and the plurality of sets of attributes.

20. The computer of claim 19, the operations comprising:
providing the first document profile to a retrieval augmented generation (RAG) system, wherein the RAG system generates a response to a query based upon the first document profile.
